(19) United States
(12) Patent Application Publication
(10) Pub. No.: US 2006/0134381 A1
(43) Pub. Date: Jun. 22, 2006

(54) Cover skin with high and low gloss

(75) Inventors: Frederick J. Homburg, Woodhaven, MI (US); Aaron Wisniewski, Plymouth, MI (US); Robert Reighard, Toledo, OH (US)

Correspondence Address: VISTEON, C/O BRINKS HOFER GILSON & LIONE, PO BOX 10395, CHICAGO, IL, 60610, US

(73) Assignee: Visteon Global Technologies, Inc.

(21) Appl. No.: 11/016,791

(22) Filed: Dec. 20, 2004

(51) Int. Cl. G11B 5/64

(52) U.S. Cl. 428/141

(57) ABSTRACT

A vacuum formed trim component cover skin having first and second portions respectively defining first and second surface finish glosses, wherein the first gloss is a higher gloss than the second gloss by a differential of greater than four.

### BACKGROUND

1. Field of the Invention

The present invention generally relates to a cover skin of a trim component. More specifically, the invention relates to a trim panel cover skin for the interior of an automotive vehicle, in which different sections of the cover skin exhibit significantly different gloss levels and, in particular, high and low gloss levels.

2. Description of Related Art

Current techniques and materials for manufacturing internal automotive trim components produces trim components in which the plastic cover skin has a consistent gloss across its entire surface. This consistent gloss is a requirement typically specified by the original equipment manufacturers. Often imparted into these cover skins is a grain pattern designed to simulate the effect or appearance of a natural material covering the trim component.

Several methods are used to form the cover skins used in the industry today. One such method involves the spraying or coating of a two-component liquid urethane thermoset, of low viscosity, on to a tool having a grain pattern imparted therein. This material is a thermoset material and upon curing of the material, it picks up the grain from the tool. Cover skins formed in this manner are generally thicker and heavier, which in turn makes them more difficult to work with when applying the cover skin to form an internal trim component.

Another method for making cover skins and imparting a grain effect on them is to form a cast, slush, or rotary molded skin. In this manufacturing method, a thermoplastic urethane, polyvinyl chloride (PVC) or thermoplastic olefin is provided within a mold cavity as a powder or liquid. One of the surfaces of the mold cavity has the desired grain pattern formed in its surface. As the mold is heated up, the powder melts or the liquid solidifies in the tool and coats the cavity. The tooling may be rotated so as to insure coverage of the mold cavity with the material. Upon cooling of the material, the thermoplastic urethane solidifies taking on the grain pattern of the tooling. As with the previously discussed method, cover skins formed in this manner tend to be thick and heavy.

Two types of vacuum forming methods are also used to manufacture thinner and lighter cover skins. One is known as positive vacuum forming, while the other is conversely known as negative vacuum forming.

With positive vacuum forming methods, an extruded thermoplastic sheet is provided with a grain pattern. The grain pattern is formed on the thermoplastic sheet during the sheet-forming process by passing the sheet through a calendaring roll or other device immediately following the extrusion step. The thermoplastic sheet may be thermoplastic olefin or PVC. Afterward, the cover skin is heated, stretched and vacuum formed onto a mold to impart the desired shape to the cover skin. During this vacuum forming process, the grain pattern is not forced into contact with the mold surfaces (hence the term “positive”). The backside (non-grained side of the sheet) contacts the vacuum form tool surface. As a result of the cover skin being stretched out and then vacuum formed, some of the effect of the grain pattern is lost. This loss is generally known as “grain wash”. Another drawback of this type of manufacturing is that the corners of the shaped article tend to have a thinned cross-section as a result of the required stretching.

In negative vacuum forming, the extruded flat sheet of the material is provided without any grain pattern formed on it or with only a slight grain pattern. The grain pattern on the displayed side of the cover skin (the “A” surface) is created in the surface of the sheet as a result of the pattern being formed in the surface of the mold or tool. Accordingly, the sheet material is heated to a softened state, stretched and vacuum formed into the shape of the mold. The mold not only forms the overall shape of the cover skin, but also imparts the grain structure into that surface of the cover skin contacting the mold. Cover skins manufactured today according to this method provide the trim component with a consistent and uniform gloss.

In each of the above manufacturing methods the cover skin may be provided with a coating to enhance the uniform nature of the gloss and to give the cover skin abrasion resistance, UV protection, and other desired characteristics. The coating may be applied to the sheet material prior to forming, may be applied to the surface of the tool or mold, or may be applied to the cover skin after its manufacture and prior to its incorporation into the resultant interior trim component.

In the above instances of vacuum formed cover skins, the resultant cover skin and the desired effect is one of generally uniform gloss. A normal variation in the gloss of a resultant article would be the target value of the gloss plus or minus 0.5, as measured with a 60 degree gloss meter. An abnormal variation in the gloss would generally be the target value of the gloss plus or minus 1.5 to 2. However, while the above are slight variations in the gloss levels found in products utilizing existing technology and materials, these variations do not constitute a significant difference in gloss as is further discussed in this disclosure.

It is noted that all cover skins may exhibit measured gloss variations on a single part due to different grains in different parts of the part. Aggressive grain patterns scatter light more than softer, less aggressive grain patterns. Thus, the measured gloss (the amount of light reflected from the surface and detected by a sensor at a fixed angle to the surface) will be less for an aggressive grain pattern than for the soft grain pattern and will not vary significantly over an area of the same pattern. Surface finish gloss, on the other hand, is not a function of the grain pattern. Rather, it is a function of the micro-details of the tool surface that are copied into the material. The grain itself may be uniform all over the cover skin, but a portion of the grain provided with micro-details giving that portion either a high surface finish gloss or a low surface finish gloss.

It is not possible to directly measure surface finish gloss on a patterned part because the area viewed, or sampled, by the gloss meter is too large and includes areas with and without the micro details. Measuring must be done by indirect methods. One such method is using visual acuity differences. Another method requires recreating the tooling surface finish in a flat, grainless tool, forming a cover skin thereon and measuring the gloss thereof, such as with a sixty (60) degree gloss meter.

As seen from the above, the existing manufacture techniques and constructions result in cover skins that exhibit a substantially uniform gloss. In the automotive industry, more and more emphasis is being placed on the ability of the OEMs to provide features and options which distinguish their vehicles from that of their competitors. One way in which this can be done is to provide the interior trim components with a more realistic natural material appearance, such as the appearance of genuine leather. In order to achieve this look, a substantially uniform gloss level on the cover skin would not be desired. Rather, gloss variations in the material, on the order of at least twice the abnormal variation or differential found in uniform gloss materials would be desired. More desired would be gloss level differentials of three, four or even five times that of the abnormal variation. As used herein, variations on these orders of differentials are referred to as high/low gloss or a high/low gloss effect.

In view of the above, it is apparent that there exists a need for a thin and flexible cover skin or interior automotive trim component covered with the same construction so as to provide a high/low gloss effect. It is further evident that there exists a need for a capable method of manufacturing and imparting high/low gloss into a thin and flexible cover skin or an interior trim panel component covered with the same.

### SUMMARY

In satisfying the above need, as well as overcoming the enumerated drawbacks and other limitations of the related art, the present invention provides a unitary cover skin molding having a vacuum formed primary surface and a secondary surface being opposite of the vacuum formed primary surface. The vacuum formed primary surface includes vacuum formed first and second portions, with the first portion having a first surface finish defining a first surface finish gloss and the second portion including a second surface finish defining a second surface finish gloss, the first surface finish gloss being higher than the second surface finish gloss.

In one embodiment, the first and second portions of the vacuum formed first surface define a pattern. This pattern may include raised and recessed portions and be a grain pattern, with either of the raised and recessed portions being defined as the first or second portions. In another embodiment, the pattern is a design or logo formed into the cover skin.

In an alternative embodiment, the first surface finish of the cover skin is a substantially smooth surface while the second surface finish is a rough surface. Alternatively, these may be reversed.

Various configurations of the first and second portions can be provided. For example, the vacuum formed first portion may at least partially circumscribe the vacuumed formed second portion or vice versa. In another configuration, one of the vacuum formed first and second portions is located on an upper part and the other is located on a lower part of the cover skin or both are located on the upper or lower part.

Preferably, the first and second surface finish glosses are different by a differential of at least greater than 4. In a most preferred embodiment, the differential would be greater than 15.

In another aspect, the present invention provides for a method of making a cover skin comprising: heating a flexible film sheet to a predetermined temperature; locating the heated film over a mold having a patterned surface, the patterned surface of the mold including a first portion having a generally smooth surface finish and a second portion having a generally rough surface finish to impart a first surface finish on parts of the flexible film corresponding to the first portion and imparting a second surface finish on parts of the flexible film corresponding to the second portion, drawing the flexible film into contact with the mold and the patterned surface by applying a vacuum through the mold; holding the vacuum and thereby forming a vacuum molded film imparted with the first and second surface finishes; releasing the vacuum and releasing the molded film from the mold; cooling and curing the molded film so as to form a first surface finish gloss on the parts of the molded film corresponding to the first surface finish and a second surface finish gloss on the parts of the molded film corresponding to the second surface finish, wherein the first surface finish gloss is greater than the second surface finish gloss.

Further objects, features and advantages of this invention will become readily apparent to a person skilled in the art after a review of the following description, with reference to the drawings and claims that are appended to and form a part of this specification.

### BRIEF DESCRIPTION OF THE DRAWINGS

FIG. 1 is a perspective view of an instrument panel exhibiting high and low gloss and embodying the principles of the present invention;

FIG. 2 is an enlarged plan view of a portion of a trim panel cover skin embodying the principles of the present invention;

FIG. 3A is a cross-sectional view generally taken along line 3-3 of a negative vacuum formed cover skin in association with the mold tooling after molding and having a grain pattern imparted to the cover skin with micro-details on the surface finish of the pattern;

FIGS. 3B-D are cross-sectional views of cover skins after molding having a grain pattern imparted thereto and illustrating different surfaces of the grain pattern exhibiting different surface finish glosses;

FIG. 4 is a cross-sectional view of a portion of a trim panel cover skin according to another embodiment of the present invention;

FIG. 5 is a cross-sectional view generally taken along line 5-5 in FIG. 4 of a negative vacuum formed cover skin in association with the mold tooling after molding so as to impart a grain pattern to the cover skin with micro-details in a generally flat surface;

FIG. 6 is a perspective view of a interior automotive trim component, and instrument panel, according to another embodiment of the present invention;

FIG. 7 is a perspective view of an interior automotive trim component according to a further embodiment of the present invention;

FIG. 8 is yet another embodiment of an interior automotive trim component embodying the principles of the present invention; and

FIG. 9 is a still further embodiment of an automotive interior trim component embodying the principles of the present invention.

### DETAILED DESCRIPTION OF THE PREFERRED EMBODIMENTS

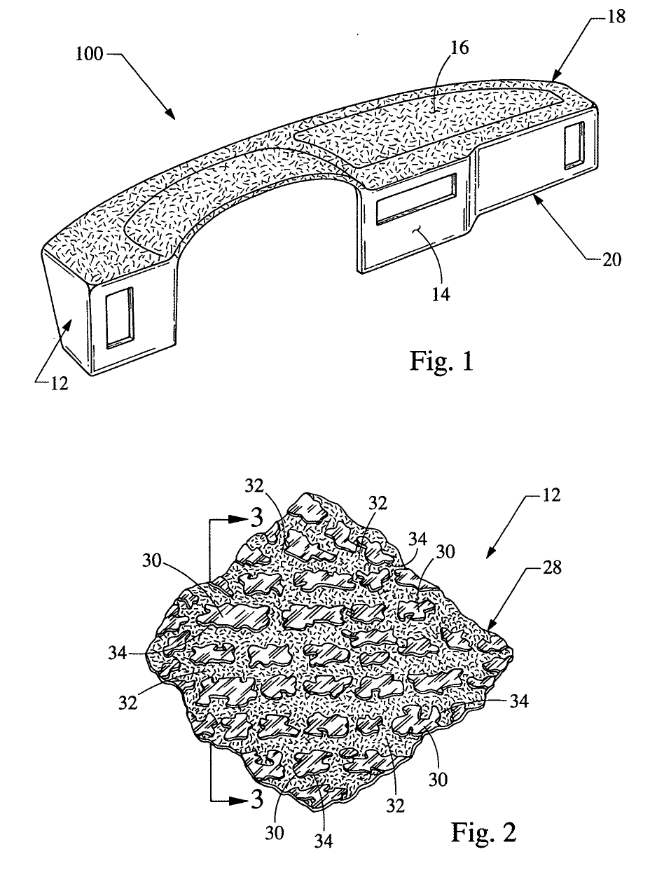

Referring now to the drawings, an interior automotive trim component embodying the principles of the present invention is illustrated in FIG. 1 and generally designated at 10. As seen in FIG. 1 the trim component 10 is illustrated as an instrument panel. While illustrated as such, it will be appreciated by those skilled in the art that the present invention is applicable to a wide range of interior automotive trim components including door panels, seats, center consoles, headliners, visors, pillars, etc. Accordingly, the illustrations provided within this specification are for illustrative purposes only and are not intended, nor should they be interpreted, as limiting the scope of the present invention.

As seen in FIG. 1, the trim component 10 has been formed into the desired shape and is provided with a cover skin 12 that has the unique characteristic of being able to exhibit areas of high gloss 14 and areas of low gloss 16. In FIG. 1, an upper portion 18 of the trim component 10 is the low gloss area 16 while a lower portion 20 is the high gloss area 14. It will be appreciated that being able to form an upper portion 18 of the component 10 as a low gloss area 16 will have benefits on days of bright sunshine. Additionally, being able to form immediately adjacent thereto a lower portion 20 of a contrasting high gloss area will be aesthetically pleasing to consumers. As mentioned above in the background section of this specification, at present original equipment manufacturers specify that the cover skin of the trim component exhibit a specific gloss and this gloss be uniform across the component. While the original equipment manufacturers specify that the gloss be uniform, there is currently no technique by which a light weight and highly flexible cover skin, having areas of alternating high gloss and low gloss, can be formed. Spray, liquid, and powder techniques, since they employ the material in a low viscosity liquid state, do allow for good conforming to the surface detail of the tool and produce stable details in the cover skin due to low/no induced stress in the resulting cover skin. However, these covers skins are heavier and less easy to work with than vacuum formed cover skins. Vacuum formed cover skins, on the other hand, while being light weight and easy to work with, do not retain the level of surface details from the tooling as the prior mentioned methods. This is believed to be because of the higher viscosity of the material (a heated visco-elastic material) when brought into contact with the mold and its surface details and thus the already present memory in the material. The inventors of the present invention believe that original equipment manufacturers will be willing to implement trim components having high and low gloss regions in an effort to distinguish their products from other products on the market. Additionally, it is believed that consumers will find such products aesthetically pleasing.

In view of the above, the present inventors developed a lightweight and flexible cover skin with areas of high and low gloss that could be used in automotive trim components.

As the terms are used herein, the actual value for the gloss of a given area is not determinative of whether the area is one of high gloss or low gloss. Rather, the determination is the delta or differential between the high gloss area and the low gloss area. With the present invention, it is desired to provide areas of significant contrast. Accordingly, as used in this specification, different areas will be considered to exhibit high and low gloss if the gloss in these areas exhibit a differential of 4, which is double the amount considered to be an abnormal gloss variation in a product of uniform gloss. More preferably, the differential between the high and low gloss areas will be 6, 8, 10 and above, with the highest differential being most preferred.

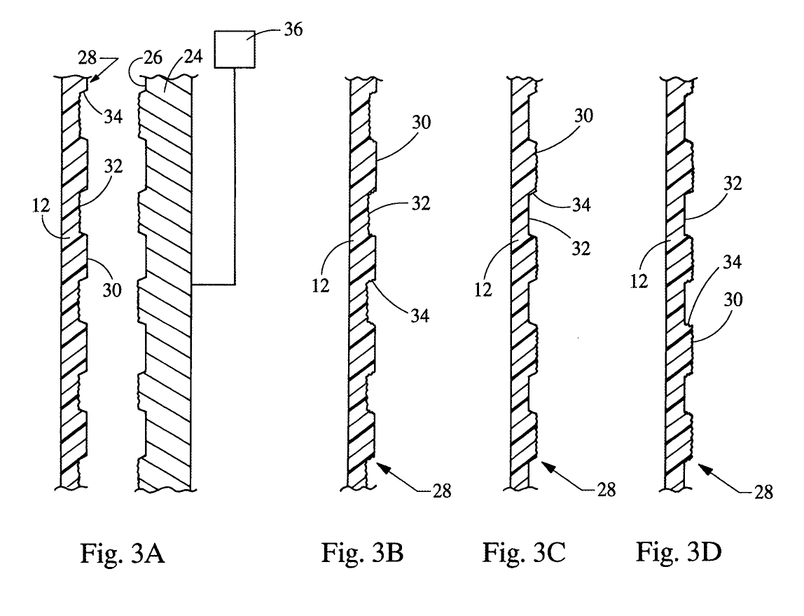

In the embodiment shown in FIGS. 2 and 3A, to form a cover skin 12 having areas of high gloss 14 and low gloss 16, a heated and softened sheet of material 22 is provided over a mold 24 whose surface 26 is imparted with a desired grain pattern 28. The grain pattern typically consists of a series of raised and recessed portions respectively designated as 30 and 32 with transition portions 34 therebetween. It is noted that the grain pattern 28 may be uniformly provided over the entire surface 26 of the mold 24 and therefore over the entire surface of the cover skin 12.

To impart high and low gloss areas, specific portions of the surface 26 of the mold 24 are embellished with different surface finishes by chemical etching, laser etching, vapor deposition, formed smooth, polishing or other means. As seen in FIG. 3A those portions of the mold surface 26 that define the raised portions 30 of the grain pattern 28, as well as those portions of the mold surface 26 defining the transition portions 34 of the grain pattern 28, have been provided with a micro-detail defining smooth surface. Those portions of the mold surface 26 that define the recessed portions 32 of the grain pattern 28 have been provided with a micro-detail imparting a rough surface by etching, deposition or other means. Thus, when a sheet of softened material 22 is brought into contact with the surface 26 of the mold 24 and a vacuum is applied from a vacuum source 36 through the mold 24, the sheet of material 22 is imparted with the grain pattern 28 and micro-detail such that the raised portions and the transition portions 34 will exhibit a particular surface finish gloss, while the recessed portions 32 will exhibit a different surface finish gloss. The combination of these portions in a given area of the cover skin provides that area of the cover skin 12 with the measured gloss for that area. Other areas of the cover skin may be similarly imparted with the grain pattern. However, selective portions of the grain pattern 28 may omit either the smooth or rough micro-detail surface finish. As a result, these other areas of the cover skin 12 will exhibit a different measured gloss from that area of the cover skin illustrated in FIG. 2.

FIGS. 3B, C and D illustrate alternative variations of this cover skin in which various ones of the raised portions 30, recessed portions 32 and transition portions 34 have been provided with the smooth or rough micro-detail surface finish.

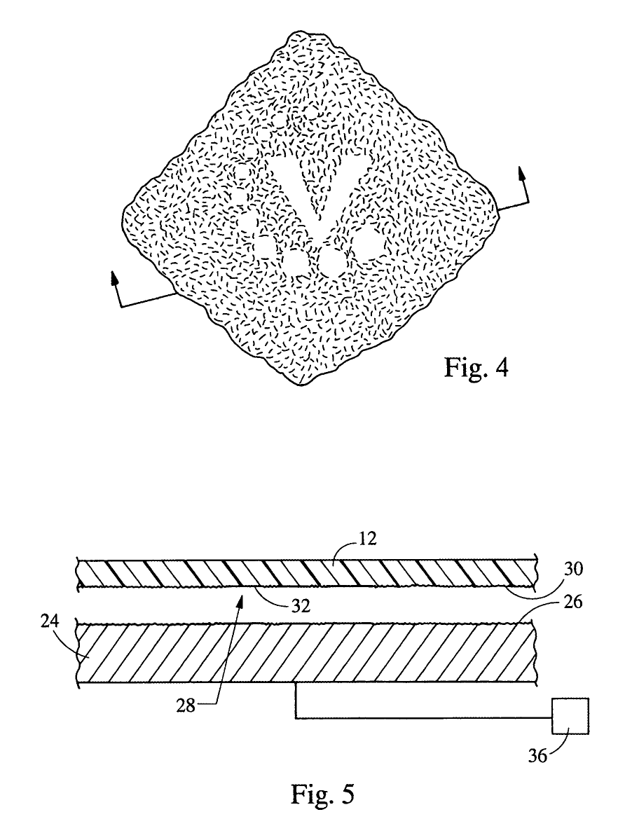

FIGS. 4 and 5 illustrate a portion of a cover skin 12 without a grain pattern formed therein. Instead, various portions of the cover skin 12 are provided with different micro-detail surface finishes, resulting in a logo or design 35 being provided in the cover skin 12. While illustrated with the design 35 being high gloss area and the surrounding portion being a low gloss area, the high and low gloss area could readily be reversed.

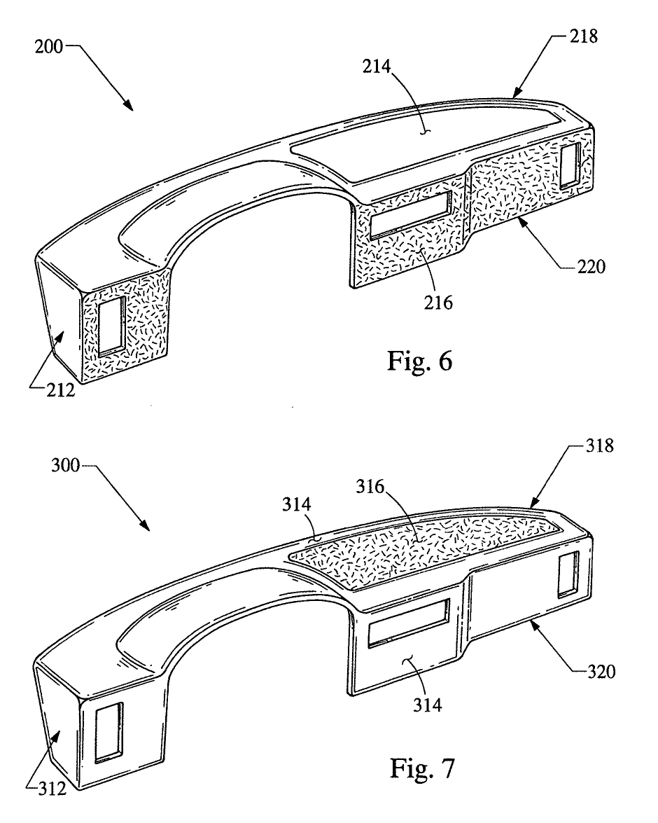

Referring now to FIG. 6, illustrated therein is another embodiment of an interior automotive trim component 200 incorporating the principles of the present invention. The trim component 200 includes a cover skin 212 having a high gloss area 214 and a low gloss area 216. In this embodiment, the lower portion 220 of the trim component 200 is provided with the low gloss area 216 while the upper portion 218 is provided as the high gloss area 214. Obviously, the whole cover skin 212, just the upper portion 218 or just the lower portion 220 may be provided with a grain pattern in the cover skin 212.

In the embodiment seen in FIG. 7, the interior automotive trim component 300 has a cover skin 312 in which a high gloss area 314 completely circumscribes a low gloss area 316 in the upper portion 318 of the component 300. The lower portion 320 of the component 300 is also provided as a high gloss area 314. Alternatively, the high gloss area 314 and the low gloss area 316 could be provided in a reverse fashion where the low gloss area 316 encircled the high gloss area 314. A grain pattern could be provided throughout or selectively in the cover skin 312.

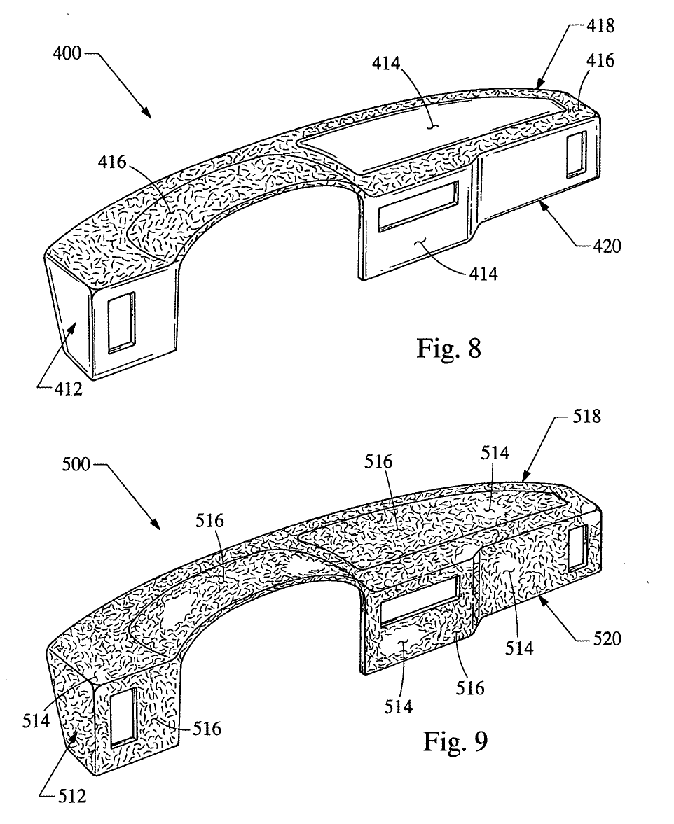

Referring to FIG. 8, the interior automotive trim component 400 seen therein has a cover skin 412 in which a high gloss area 414 is enclosed by or circumscribed by a low gloss area 416 on an upper portion 418 of the component 400. The lower portion 420 of the component 400 is provided with a high gloss area thereon. As with the prior embodiment, the high gloss areas 414 and the low gloss areas 416 could be reversed and so provided on the component 400 is desired. As with prior embodiments, a grain pattern could be provided in the cover skin 412, throughout or in selective regions.

In the embodiment of FIG. 9, the interior automotive trim component 500 has a cover skin 512 which is substantially covered with a low gloss area 516 on both the upper portion 518 and the lower portion 520 thereof. However, simulated worn areas are provided in the component 500 and are represented by high gloss areas 514 provided selectively throughout the component. As seen therein these areas 514 do on cover complete regions of the component 500, but rather simulate the wear experienced by natural material over extended use. In forming the areas 514, larger sections of the cover skin 512 may be provided with areas lacking the grain pattern. These areas may be comprised of larger raised portion or larger recessed portions. In this context the term “larger” is used relative to the remaining raised and recessed portions as provided to define the grain pattern itself. When providing larger areas in the cover skin 512 lacking the grain pattern, these areas can be considered to simulate “worn” areas of natural material surrounded by “unworn” areas. In either instance, the “worn” area may be an area of higher gloss or lower gloss depending on the desired effect.

Even with proper surface preparation to form micro-details in the mold, as discussed above, traditional cover skin materials do not provide the ability to achieve the sought after high/low gloss effect. The difference between gloss levels measured, for these conventional materials, when formed against a highly smooth (glass) surface and against a roughened (sand blasted) surface, was insufficient to produce the desired high/low gloss effect. Various conventional PVC materials were negative vacuum formed and none were found to produce the desired high/low gloss effect. In view of this, a number of thermoplastic olefin sheets, which are not traditional cover skin materials for cover skins of interior automotive trim components, were tested. After negative vacuum forming (mold surface temperature between 100° F. and 160° F.) their resulting gloss was measured using a calibrated 60 degree gloss meter (manufactured by BYK Gardner) These materials included the following: Kyowa KVT-001 topcoated; Kyowa KVT-001 uncoated; Solvay Respond L10; Solvay Respond L9; Solvay Respond L8A; Solvay Respond L8; and Solvay Respond L6. These materials are available, respectively, from Kyowa Leather Cloth Co., Ltd., Japan and Solvay Engineered Polymers, Grand Prairie, Tex. The greatest surface finish gloss differential was only found to be 1.2 for these materials.

Several factors are believed by the inventors to contribute to the ability of a material to produce the desired high/low gloss effect. Some of these factors include: lower filler (e.g. talc) content in the material; and/or the presence and type of elastomers (e.g. rubber) as an additive in the materials; the presence of polyurethane or polypropylene in the base material mixture. Various thermoplastic olefin sheets believed to have the above characteristics were similarly negative vacuum formed (mold surface temperatures between 100° F. and 160° F.; material temperatures between 330° F. and 420° F.) and their resulting gloss measured. These materials included the following: DuPont Dow 1458-51-3; DuPont Dow 1458-51-4; DuPont Dow 1458-51-5; Sumitomo WT-318; and DuPont Canada 9300D (respectively available from DuPont-Dow Elastomers, Sumitomo Chemical America, Inc., and DuPont Canada, Inc.). Surface finish gloss level differentials were determined to be 17.9, 13.6, 16.0, 6.6 and 16.9, respectively, for these materials.

While the tested sheets were not top coated on the “A” surface, it is believed that top coating could be utilized without affecting the high/low gloss effect. Similarly, a primer (such as a urethane primer) may be provided on the “B” surface of the cover skin to aid in subsequent processing and formation of the trim component (aiding in adhesion of the cover skin to the substrate of the trim component or to an intervening material so as to provide a desired “soft-feel” to the trim component).

As a person skilled in the art will readily appreciate, the above description is meant as an illustration of implementation of the principles of this invention. This description is not intended to limit the scope or application of this invention in that the invention is susceptible to modification, variation and change, without departing from the spirit of this invention, as defined by the following claims.

1. A trim component cover skin comprising:
a unitary skin molding having a vacuum formed primary surface and a secondary surface, said secondary surface being generally opposite of said vacuum formed primary surface, said vacuum formed primary surface having vacuum formed first and second portions, said vacuum formed first portion including a first surface finish defining a first gloss and said vacuum formed second portion including a second surface finish defining a second gloss, wherein said first gloss is higher than said second gloss.

2. The cover skin as set forth in claim 1 wherein said vacuum formed first and second portions define a pattern.

3. The cover skin as set forth in claim 2 where said pattern has raised portions and recessed portions.

4. The cover skin as set forth in claim 3 wherein said vacuum formed first portion includes said raised portions of said pattern and said vacuum formed second portion includes said recessed portions of said pattern.

5. The cover skin as set forth in claim 3 wherein said vacuum formed second portion includes said raised portions of said pattern and said vacuum formed first portion includes said recessed portions of said pattern.

6. The cover skin as set forth in claim 2 wherein said pattern is a grain pattern.

7. The cover skin as set forth in claim 1 wherein said first surface finish is a substantially smooth surface.

8. The cover skin as set forth in claim 1 wherein said first surface finish is a rough surface.

9. The cover skin as set forth in claim 1 wherein said vacuum formed first and second portions both include raised and recessed portions.

10. The cover skin as set forth in claim 1 wherein said vacuum formed first portion is adjacent to said vacuum formed second portion.

11. The cover skin as set forth in claim 1 wherein one of said vacuum formed first and second portions at least partially circumscribes the other of said vacuum formed first and second portions.

12. The cover skin as set forth in claim 1 wherein one of said vacuum formed first and second portions is located on an upper part and the other of said vacuum formed first and second portions is located on a lower part of said cover skin.

13. The cover skin as set forth in claim 1 further comprising an upper part and a lower part and said vacuum formed first and second portions are located on said upper part.

14. The cover skin as set forth in claim 1 wherein said first and second glosses as measured by a 60 degree surface gloss meter are different by a differential of greater than 5.

15. The cover skin as set forth in claim 1 wherein said first and second glosses as measured by a 60 degree surface gloss meter are different by a differential of greater than 7.

16. The cover skin as set forth in claim 1 wherein said cover skin molding is a thermoplastic material.

17. The cover skin as set forth in claim 1 wherein said cover skin molding is a thermoplastic olefin.

18. A method of making a trim component cover skin comprising:
heating a flexible film sheet to a predetermined temperature;
locating the heated film over a mold having a patterned surface, the patterned surface of the mold including a first portion having a generally smooth surface finish and a second portion having a generally rough surface finish to impart a first surface finish on parts of the flexible film corresponding to said first portion and imparting a second surface finish on parts of the flexible film corresponding to said second portion;
forcing the flexible film into contact with the mold and the patterned surface, said forcing step including applying a vacuum through the mold;
holding the vacuum thereby forming a vacuum molded film imparted with the first and second surface finishes;
releasing the vacuum and releasing the molded film from the mold;
cooling and curing the molded film so as to form a first gloss on the parts of the molded film corresponding to the first surface finish and a second gloss on the parts of the molded film corresponding to the second surface finish, wherein the first gloss is greater than the second gloss.

19. The method of making a trim component cover skin according to claim 18 wherein the first surface finish is formed adjacent to the second surface finish.

20. The method of making a trim component cover skin according to claim 19 wherein one of the first and second surface finishes is formed to at least partially circumscribe the other of the second and first surface finishes.

21. The method of making a trim component cover skin according to claim 19 wherein the patterned mold surface includes a plurality of raised portions and a plurality of recessed portions.

22. The method of making a trim component cover skin according to claim 21 wherein one of the first and second portions includes the raised portions and the other of the first and second portions includes the recessed portions.

23. The method of making a trim component cover skin according to claim 19 wherein one of the first and second portions corresponds with a generally upper portion of the cover skin and the other of the first and second portions corresponds with a lower portion of the cover skin.
